(19) United States
(12) Patent Application Publication
(10) Pub. No.: US 2023/0281931 A1
(43) Pub. Date: Sep. 7, 2023

(54) Virtual Wig Display Device

(71) Applicant: LaQuinda Carraway, Rochester, NY (US)

(72) Inventor: LaQuinda Carraway, Rochester, NY (US)

(21) Appl. No.: 18/175,613

(22) Filed: Feb. 28, 2023

Related U.S. Application Data
(60) Provisional application No. 63/315,555, filed on Mar. 2, 2022.

(51) Int. Cl. G06T 19/00; G06Q 30/0601

(52) U.S. Cl. CPC G06T 19/00; G06Q 30/0643; H04N 1/34

(57) ABSTRACT

The present invention relates to a virtual wig display device that can be used to virtually try on a wig. A scanner of the device can be used to create a scan of a user's head. Then, a simulator software allows a user to select at least one virtual wig to overlay over the scan. This allows a user to view how a physical version of the virtual wig may look on their head. Then, a user can print out the virtual wig overlay over the head scan using a printer of the device.

### CROSS-REFERENCE TO RELATED APPLICATION

The present application claims priority to, and the benefit of, U.S. Provisional Application No. 63/315,555, which was filed on Mar. 2, 2022, and is incorporated herein by reference in its entirety.

### FIELD OF THE INVENTION

The present invention relates generally to the field of hair wigs. More specifically, the present invention relates to a virtual wig display device that allows a user to virtually try on a wig. A scanner of the device can be used to create a scan of a user's head, wherein a simulator software of the device allows a user to select at least one virtual wig to overlay over the scan. Accordingly, the present disclosure makes specific reference thereto. Nonetheless, it is to be appreciated that aspects of the present invention are also equally applicable to other like applications, devices, and methods of manufacture.

### BACKGROUND

Many individuals wear wigs. However, trying to choose a wig can be an incredibly difficult and overwhelming experience. Wigs can be very expensive to purchase. As a result, it can be expensive, frustrating, and even embarrassing if an individual purchases a wig but then decides the wig no longer fits their desired look or needs.

Therefore, there exists a long-felt need in the art for a device that aids a user in purchasing a wig. More specifically, there exists a long-felt need in the art for a virtual wig display device. There also exists a long-felt need in the art for a virtual wig display device that allows a user to view a wig on their head without having to purchase the wig. In addition, there exists a long-felt need in the art for a virtual wig display device that allows a user to view a wig on their head without having to physically possess the wig. Further, there exists a long-felt need in the art for a virtual wig display device that allows a user to view a plurality of wig styles on their head in an efficient manner.

The subject matter disclosed and claimed herein, in one embodiment thereof, comprises a virtual wig display device. The device is comprised of a body having at least one scanner, at least one control interface, at least one simulator software, and at least one printer. The scanner can be used to create a scan of a user's head. Then, the simulator software allows a user to select at least one virtual wig to overlay over the scan. This allows a user to view how a physical version of the virtual wig may look on their head. Then, a user can print out the virtual wig overlay over the head scan using the printer of the device.

In this manner, the virtual wig display device of the present invention accomplishes all the foregoing objectives and provides a device that aids a user in purchasing a wig. To do so, the device allows a user to view a wig on their head without having to purchase the wig and without having to physically possess the wig. Further, the device allows a user to view a plurality of wig styles on their head in an efficient manner.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a virtual wig display device. The device is comprised of a body having at least one scanner, at least one control interface, at least one simulator software, and at least one printer. During use, the device allows a user to virtually view various styles of wigs on a virtual scan of their head without having to physically possess said wigs.

More specifically, the scanner creates a scan of a user's head once the user's head is present within the field of view of the scanner. The scanner may be any form of 2D or 3D scanning technology known in the art, including, but not limited to, a camera or a laser scanner. Once the scan has been completed, a user can view the scan on a display of the device.

The device is also comprised of a simulator software that allows a user to virtually place at least one style of virtual wig on the scan uploaded to the device. This allows a user to view the wig on their head scan without having to physically have (and/or purchase) the wig and physically place the wig on their head. The software preferably has at least one virtual wig for a user to choose from, wherein the wig may be of any style, color, cut, etc., known in the art. Once a user uploads the scan via the software, a virtual wig can be selected 144. Then, the virtual wig can be viewed on the scan of the user's head.

In a further embodiment, a user can print each virtual wig overlay via at least one printer of the device. In this embodiment, the device may also have at least one payment interface that can be used to charge a user for each representation that is printed and/or selected. The interface may be any type of payment interface known in the art, such as, but not limited to, a credit card reader. The reader may be a swipe reader or a touchless reader.

The present invention is also comprised of a method of using the device. First, a device is provided wherein the device is comprised of a scanner, a display, a simulator software, and a printer. Next, a user can scan their head via the scanner. Then, a user can use the simulator software to select and virtually overlay at least one wig on the head scan. Once a wig has been selected and overlayed, a user can then print the virtual representation of the wig via the printer.

Accordingly, the virtual wig display device of the present invention is particularly advantageous as it provides a device that aids a user in purchasing a wig. To do so, the device allows a user to view a wig on their head without having to purchase the wig and without having to physically possess the wig. Further, the device allows a user to view a plurality of wig styles on their head in an efficient manner. In this manner, the virtual wig display device overcomes the limitations of existing methods of purchasing wigs known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a virtual wig display device of the present invention in accordance with the disclosed architecture;

FIG. 2 illustrates a graphical view of a simulator software of one potential embodiment of a virtual wig display device of the present invention in accordance with the disclosed architecture; and

FIG. 3 illustrates a flowchart of a method of using one potential embodiment of a virtual wig display device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that aids a user in purchasing a wig. More specifically, there exists a long-felt need in the art for a virtual wig display device. There also exists a long-felt need in the art for a virtual wig display device that allows a user to view a wig on their head without having to purchase the wig. In addition, there exists a long-felt need in the art for a virtual wig display device that allows a user to view a wig on their head without having to physically possess the wig. Further, there exists a long-felt need in the art for a virtual wig display device that allows a user to view a plurality of wig styles on their head in an efficient manner.

The present invention, in one exemplary embodiment, is comprised of a virtual wig display device comprised of a body having at least one scanner, at least one control interface, at least one simulator software, and at least one printer. During use, the device allows a user to virtually view various styles of wigs on a virtual scan of their head without having to physically possess said wigs. To do so, the scanner creates a scan of a user's head once the user's head is present within the field of view of the scanner. The scanner may be any form of 2D or 3D scanning technology known in the art, including, but not limited to, a camera or a laser scanner. Once the scan has been completed, a user can view the scan on a display of the device.

The device is also comprised of a simulator software. The software allows a user to virtually place at least one style of virtual wig on the scan uploaded to the device to allow a user to view the wig on their head scan without having to physically have (and/or purchase) the wig and physically place the wig on their head. The software preferably has at least one virtual wig for a user to choose from, wherein the wig may be of any style, color, cut, etc., known in the art. Once a user uploads the scan via the software, a virtual wig can be selected 144. Then, the virtual wig can be viewed on the scan of the user's head.

In a further embodiment, a user can print each virtual wig overlay via at least one printer of the device. In this embodiment, the device may also have at least one payment interface that can be used to charge a user for each representation that is printed and/or selected. The interface may be any type of payment interface known in the art, such as, but not limited to, a credit card reader. The reader may be a swipe reader or a touchless reader.

The present is also comprised of a method of using the device. First, a device is provided wherein the device is comprised of a scanner, a display, a simulator software, and a printer. Next, a user can scan their head via the scanner. Then, a user can use the simulator software to select and virtually overlay at least one wig on the head scan. Once a wig has been selected and overlayed, a user can then print the virtual representation of the wig via the printer.

Accordingly, the virtual wig display device of the present invention is particularly advantageous as it provides a device that aids a user in purchasing a wig. To do so, the device allows a user to view a wig on their head without having to purchase the wig and without having to physically possess the wig. Further, the device allows a user to view a plurality of wig styles on their head in an efficient manner. In this manner, the virtual wig display device overcomes the limitations of existing methods of purchasing wigs known in the art.

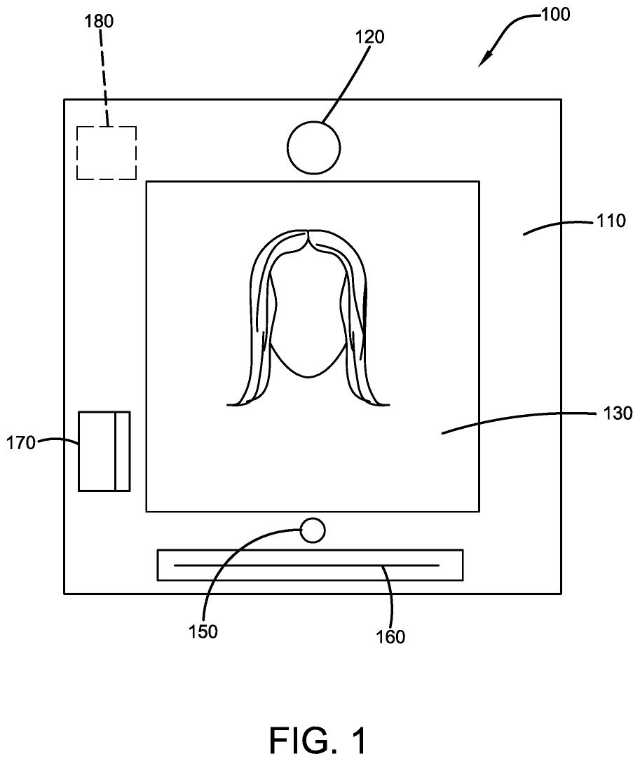

Referring initially to the drawings, FIG. 1 illustrates a front view of one potential embodiment of a virtual wig display device 100 of the present invention in accordance with the disclosed architecture. The device 100 is comprised of a body 110 having at least one scanner 120, at least one control interface 130, at least one simulator software 140, and at least one printer 160. The device 100 is intended to be used to allow a user to virtually view various styles of wigs on a virtual scan of their head without having to physically possess said wigs.

To accomplish this, the device 100 is comprised of at least one scanner 120. The scanner 120 creates a 2D or 3D scan of a user's head once the user's head is present within the field of view of the scanner 120. In the preferred embodiment, the scanner 120 is comprised of a camera (of any type known in the art). However, the scanner 120 may be any form of 2D or 3D scanning technology known in the art, including, but not limited to, a laser scanner. The scanner 120 may allow a user to upload front and side scans of their head to the device 100 and/or full 360-degree head scans.

Once the scan has been completed, a user can view the scan on a display 130 of the device 100. The display 130 may be any type of electronic display screen known in the art. However, the display 130 is preferably a touchscreen display that allows a user to control the functions of the device 100 via touch input.

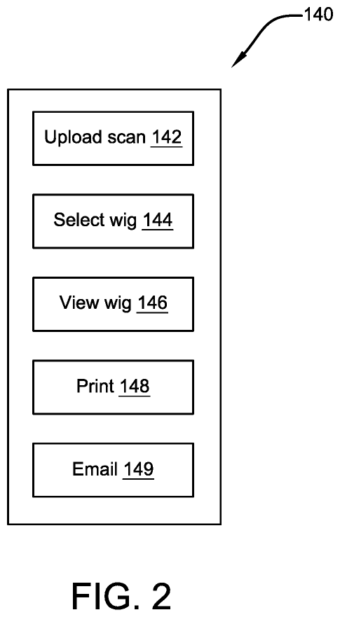

The device 100 is also comprised of a simulator software 140, as seen in FIG. 2. The software 140 allows a user to virtually place at least one style of virtual wig on the scan uploaded to the device 100. This allows a user to view the wig on their head scan without having to physically have (and/or purchase) the wig and physically place the wig on their head. The software 140 preferably has at least one virtual wig for a user to choose from. Said virtual wig may be of any style, color, cut, etc., known in the art.

Once a user uploads the scan 142 via the software 140, a virtual wig can be selected 144. Then, the virtual wig can be viewed on the scan of the user's head 146. In an embodiment with a 2D scan, the wig can be viewed 146 in 2D front and side views of a user's head. In a 3D scan embodiment, the scan can be rotated 360 degrees on the scan to give a user a 360-degree view of what a real, physical version of the wig would look like on their head. Switching between wig styles and scan views may be done via touching the display 130 or by at least one physical button 150 on the body 110 of the device 100.

In a further embodiment, a user can print each virtual wig overlay via at least one printer 160 of the device 100. The printer 160 may be any type of color or grayscale printer known in the art. This allows a user to physically possess copies of each virtual wig representation. Printing of each representation can be controlled via the touchscreen display 130 or by at least one button 150.

The device 100 may also have at least one payment interface 170. The interface 170 can be used to charge a user for each representation that is printed and/or selected. The interface 170 may be any type of payment interface known in the art, such as, but not limited to, a credit card reader. The reader may be a swipe reader or a touchless reader.

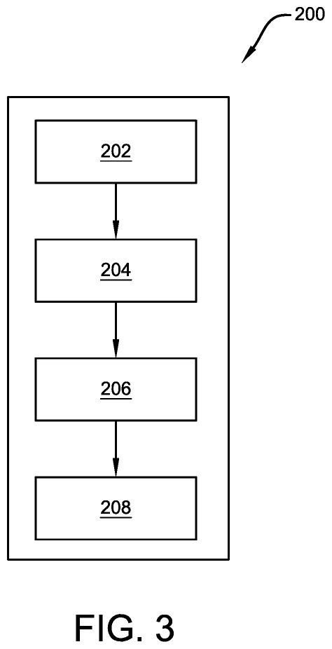

FIG. 3 illustrates a flowchart of a method of using 200 one potential embodiment of a virtual wig display device 100 of the present invention in accordance with the disclosed architecture. The present is also comprised of a method of using 200 the device 100. First, a device 100 is provided wherein the device 100 is comprised of a scanner 120, a display 130, a simulator software 140, and a printer 160 [Step 202]. Next, a user can scan their head in a 2D or a 3D view via the scanner 120 [Step 204]. Then, a user can use the simulator software 140 to select and virtually overlay at least one wig on the head scan [Step 206]. Once a wig has been selected and overlayed, a user can then print the virtual representation of the wig via the printer [Step 208].

In another embodiment, the virtual wig overlay may be emailed 149 to a user via the software 140 using at least one wireless communication module 180 of the device 100. The module may include (but is not limited to) a Wi-Fi or a Bluetooth wireless communication module.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “virtual wig display device” and “device” are interchangeable and refer to the virtual wig display device 100 of the present invention.

Notwithstanding the foregoing, the virtual wig display device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the virtual wig display device 100 as shown in the FIGS. are for illustrative purposes only, and that many other sizes and shapes of the virtual wig display device 100 are well within the scope of the present disclosure. Although the dimensions of the virtual wig display device 100 are important design parameters for user convenience, the virtual wig display device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A virtual wig display device comprising:
a scanner;
a display; and
a simulation software comprised of a virtual wig.

2. The virtual wig display device of claim 1, wherein the scanner is comprised of a camera.

3. The virtual wig display device of claim 1, wherein the display is comprised of an electronic display.

4. The virtual wig display device of claim 1, wherein the scanner creates a scan that can be uploaded to the simulation software.

5. The virtual wig display device of claim 4, wherein the scan is comprised of a 3D scan.

6. The virtual wig display device of claim 4, wherein the virtual wig is overlayed over the scan.

7. The virtual wig display device of claim 1 further comprised of a wireless communication module.

8. The virtual wig display device of claim 1 further comprised of a button.

9. The virtual wig display device of claim 8, wherein the button controls a function of the simulation software.

10. A virtual wig display device comprising:
a scanner;
a display;
a simulation software;
a printer;
and a payment interface.

11. The virtual wig display device of claim 10, wherein the scanner is comprised of a laser scanner.

12. The virtual wig display device of claim 10, wherein the display is comprised of a touchscreen display.

13. The virtual wig display device of claim 10, wherein the simulation software is comprised of a virtual wig.

14. The virtual wig display device of claim 13, wherein the virtual wig can be overlayed over the scan.

15. The virtual wig display device of claim 10, wherein the payment interface is comprised of a credit card reader.

16. The virtual wig display device of claim 10 further comprised of a button.

17. The virtual wig display device of claim 10, wherein the printer is comprised of a color printer.

18. A method of using a virtual wig display device, the method comprising the steps of:
providing a virtual wig display device comprised of a scanner, a display, a simulator software, and a printer;
scanning a user's head via the scanner to create a scan;
using the simulator software to select and virtually overlay a virtual wig on to the scan; and printing the scan with the virtual overlay of the wig via the printer.

19. The method of claim 18 further comprised of a step of paying via a payment interface to print the scan.

20. The method of claim 18 further comprised of a step of emailing the scan to a user via a wireless communication module.
